(19) United States
(12) Patent Application Publication
(10) Pub. No.: US 2026/0104695 A1
(43) Pub. Date: Apr. 16, 2026

(54) TOOL EDGE PARAMETER OPTIMIZATION METHOD BASED ON WORKPIECE-TOOL PERFORMANCE PARAMETERS

(71) Applicant: Harbin University of Science and Technology, Harbin (CN)

(72) Inventors: Zhipeng JIANG, Harbin (CN); Caixu YUE, Harbin (CN); Rongyi LI, Harbin (CN); Anshan ZHANG, Harbin (CN); Shiliang WEI, Harbin (CN); Xianli LIU, Harbin (CN); Yaping WANG, Harbin (CN); Fugang YAN, Harbin (CN)

(73) Assignee: Harbin University of Science and Technology, Harbin, HL (CN)

(21) Appl. No.: 19/422,410

(22) Filed: Dec. 16, 2025

(30) Foreign Application Priority Data
Mar. 6, 2025 (CN) 202510260242.2

(51) Int. Cl. G05B 19/418

(52) U.S. Cl. CPC G05B 19/41875; G05B 2219/36252

(57) ABSTRACT

The present disclosure provides a tool edge parameter optimization method based on workpiece-tool performance parameters. The method includes: obtaining cutting and workpiece characteristic parameters under different tool edge parameter combinations; establishing a tool characteristic prediction model, inputting tool edge parameters, and outputting cutting characteristic parameters; under constraint conditions, combining the tool edge parameters randomly, and inputting into the prediction model to obtain the cutting characteristic parameters; performing data processing and correlation analysis of workpiece combinations, and constructing a functional relationship among cutting characteristics, tool life coefficient and workpiece surface quality coefficient, using the genetic algorithm to iteratively optimize the individual of the initial population and extract the best tool edge parameters. The present disclosure significantly enhances the intelligence of tool design, enabling not only real-time optimization based on actual machining conditions but also effective adaptation to diverse scenarios, thereby ensuring optimal tool performance in practical applications.

### TECHNICAL FIELD

The present disclosure relates to the field of tool edge parameter optimization technology, which is a tool edge parameter optimization method based on workpiece-tool performance parameters.

### BACKGROUND

In the field of metal cutting, the cutting performance of tools is closely interrelated with the performance of the workpiece. As requirements for machining accuracy and efficiency continue to rise, the limitations of traditional single-objective tool optimization methods have become increasingly apparent. Most existing technologies focus on optimizing tool materials, coating selection, or geometric design, yet often overlook the interaction between tool cutting performance and workpiece characteristics. Moreover, they generally fail to consider the simultaneous joint optimization of both aspects. Although some studies have incorporated adaptive algorithms or optimization models, the majority of approaches still lack the capability for dynamically adjusting tool and workpiece performance during actual machining processes. As a result, these methods fall short in effectively enhancing tool life and improving the surface quality of workpieces.

In existing technologies, the patent CN118568886A discloses a method and system for designing the cutting edge of an end mill based on an equiangular spiral. The procedure includes the following steps: collecting tool parameters, such as tool diameter and length, and edge parameters, including edge radius and inclination angle; processing the tool parameters and performing correlation analysis to generate a dimensional influence coefficient that affects the edge size; and processing the edge parameters with correlation analysis to derive a shape influence coefficient that influences the edge geometry. This approach gathers relevant edge parameters, optimizes the values of the equiangular spiral function and the geometric characteristics of the edge, generates the equiangular spiral function curve based on the tool edge geometry, and ultimately obtains the geometric form of the end mill edge through this curve. It enables rapid generation of an optimal edge design, thereby improving the accuracy and efficiency of edge design.

However, the following shortcomings remain. As indicated above, the existing technology relies on static parameter analysis of the tool and workpiece and lacks an effective bidirectional feedback mechanism. This prevents real-time adjustment of the tool design according to actual machining conditions and overlooks the influence of variations in workpiece characteristics on tool performance during machining. Such one-way information flow renders the parameter optimization in tool design inadequate when confronted with complex and dynamic machining scenarios.

The information disclosed in the background section is intended only to facilitate a better understanding of the disclosed context, and thus may include details that do not form part of the existing technology known to a person of ordinary skill in the art.

### SUMMARY

The purpose of the present disclosure is to provide a tool edge parameter optimization method based on workpiece-tool performance parameters to solve the problems raised in the above background technology.

To achieve the above purpose, the present disclosure provides the following technical scheme:

A tool edge parameter optimization method based on workpiece-tool performance parameters is proposed, the specific steps include:
S1, obtaining tool cutting characteristic parameters and workpiece characteristic parameters under different combinations of tool edge parameters, tool cutting characteristic parameters include cutting speed, feed rate and cutting depth, the workpiece characteristic parameters include surface temperature, surface hardness and surface roughness, tool edge parameters include rake angle, relief angle, edge radius and rounding radius, splicing the workpiece characteristic parameters and tool edge parameters to construct an individual of an initial population;
S2, constructing a tool characteristic prediction model, using a combination of tool edge parameters of the individual of the initial population as input, and using the tool cutting characteristic parameters as a label training model to train a tool characteristic prediction model;
S3, establishing constraint conditions of the tool edge parameters, under the constraint conditions of the tool edge parameters, combining the tool edge parameters of the individual of the initial populations randomly, and inputting the tool edge parameters of the individual of the initial populations into the tool characteristic prediction model to obtain the tool cutting characteristic parameters;
S4, performing data processing and correlation analysis of the workpiece combination of the individual of the initial population to obtain a workpiece surface quality coefficient, obtaining deviation values of cutting speed, feed rate and cutting depth by using the cutting speed, feed rate, cutting depth and upper and lower limits of an ideal interval, constructing a functional relationship among the deviation values of cutting speed, feed rate, cutting depth and a tool life coefficient, constructing a functional relationship among the workpiece surface quality coefficient, the tool life coefficient and a comprehensive evaluation coefficient, using a comprehensive evaluation coefficient to comprehensively evaluate the workpiece-tool performance;
S5, taking a maximization of the comprehensive evaluation coefficient as an objective function, optimizing the individual of the initial population iteratively by a genetic algorithm under the constraint conditions of the tool edge parameters, and obtaining an optimal individual, based on the optimal individual, extracting an optimal value of tool edge parameters.

In some embodiments, splicing the workpiece characteristic parameters and tool edge parameters to construct the individual of the initial population, the specific process is as follows:
collecting workpiece characteristic parameters, including a workpiece surface temperature T, a workpiece surface hardness H and a workpiece surface roughness Rz; calibrating a combination of workpiece characteristic parameters as B, and B={T, H, RZ}, T, H, Rz denote the workpiece surface temperature, workpiece surface hardness and workpiece surface roughness in the combination of workpiece characteristic parameters, respectively; calibrating the initial population formed by splicing as Q, and the initial population Q={Q₁, Q₂, . . . , Qⱼ, . . . , Qₘ}, Qⱼ is a j-th individual in the initial population, j is an index of the individual in the initial population, and j∈[1,m], m is a count of individuals in the initial population, Qⱼ={Tⱼ, Hⱼ, R_{z}_{ⱼ}, αⱼ, βⱼ, rⱼ, Rⱼ}, where Tⱼ, Hⱼ, Rzⱼ, αⱼ, βⱼ, rⱼ, Rⱼ denote the workpiece surface temperature, workpiece surface hardness, workpiece surface roughness, rake angle, relief angle, edge radius and rounding radius of the j-th individual, respectively.

In some embodiments, the tool characteristic prediction model is composed of a deep neural network based on multi-layer perceptron; the deep neural network of the multi-layer perceptron includes an input layer, a first hidden layer, a second hidden layer, a third hidden layer and an output layer; the first hidden layer, the second hidden layer and the third hidden layer all have at least two neurons, and all use ReLU as the activation function.

A process of training the tool characteristic prediction model is as follows:
taking the rake angle, relief angle, edge radius and rounding radius of the individual of the initial population as an input, the tool cutting characteristic parameters as an output label for training, and a mean square error as a loss function, when the mean square error is within a range of [0, 0.01], the training of the tool characteristic prediction model is completed.

In some embodiments, processing the surface temperature, surface hardness, and surface roughness of the workpiece and performing a correlation analysis to obtain the workpiece surface quality coefficient, the formula is as follows:

$${Q}_{\times {s}_{j}} = \frac{{μ}_{1} \cdot {T}_{j} + {μ}_{2} \cdot {H}_{j}}{{μ}_{3} \cdot {RZ}_{j}} ;$$

where Q_{Xsj} is the workpiece surface quality coefficient of the j-th individual, the workpiece surface quality coefficient is used to comprehensively evaluate an influence of the workpiece characteristic parameters on the workpiece surface quality from the three levels of workpiece surface temperature, workpiece surface hardness and workpiece surface roughness; μ₁ is a weight coefficient of the workpiece surface temperature, μ₂ is a weight coefficient of the workpiece surface hardness, and μ₃ is a weight coefficient of the workpiece surface roughness; based on μ₁+μ₂+μ₃=1, let 0<μ₃<μ₂<μ₁<1.

In some embodiments, constructing a function between the deviation of cutting speed, feed rate, cutting depth, and tool life coefficient, the formula is as follows:

$$\{ \begin{matrix}Δ {V}_{j} = \{ \begin{matrix}{V}_{1} - {V}_{j} & {V}_{j} < {V}_{1} \\ 0 & {V}_{1} \leq {V}_{j} \leq {V}_{2} \\ {V}_{j} - {V}_{2} & {V}_{j} > {V}_{2}\end{matrix} \\ Δ {f}_{j} = \{ \begin{matrix}{f}_{1} - {f}_{j} & {f}_{j} < {f}_{1} \\ 0 & {f}_{1} \leq {f}_{j} \leq {f}_{2} \\ {f}_{j} - {f}_{2} & {f}_{j} > {f}_{2}\end{matrix} \\ Δ {d}_{j} = \{ \begin{matrix}{d}_{1} - {d}_{j} & {d}_{j} < {d}_{1} \\ 0 & {d}_{1} \leq {d}_{j} \leq {d}_{2} \\ {d}_{j} - {d}_{2} & {d}_{j} > {d}_{2}\end{matrix}\end{matrix}$$

$${DSxs}_{j} = {ρ}_{1} \cdot Δ {V}_{j} + {ρ}_{2} \cdot Δ {f}_{j} + {ρ}_{3} \cdot Δ {d}_{j} ;$$

where DSxsⱼ is a tool life coefficient of the j-th individual; the tool life coefficient is used to comprehensively evaluate an influence of tool cutting characteristic parameters on tool life from three levels: cutting speed, feed rate, and cutting depth.

ΔVⱼ is a cutting speed deviation value of the j-th individual, Vⱼ is a cutting speed mean value of the j-th individual, V₁ is a lower limit value of an ideal interval of the cutting speed, V₂ is an upper limit value of the ideal interval of the cutting speed, Δfⱼ is a feed deviation value of the j-th individual, fⱼ is a feed mean value of the j-th individual, f₁ is a lower limit value of an ideal interval of the feed, f₂ is an upper limit value of the ideal interval of the feed, Δdⱼ is a cutting depth deviation value of the j-th individual, dⱼ is a cutting depth mean value of the j-th individual, d₁ is a lower limit value of the ideal interval of the cutting depth, d₂ is an upper limit value of the ideal interval of the cutting depth;

ρ₁ is a weight of cutting speed deviation in evaluating an influence of cutting characteristic parameters on tool life; ρ₂ is a weight of feed deviation in evaluating the influence of cutting characteristic parameters on tool life, ρ₃ is a weight of cutting depth deviation in evaluating the influence of cutting characteristic parameters on tool life, on the basis of ρ₁+ρ₂+ρ₃=1, let

$$0 < {ρ}_{3} < {ρ}_{2} < {ρ}_{1} < 1.$$

In some embodiments, constructing the functional relationship between the workpiece surface quality coefficient, the tool life coefficient, and the comprehensive evaluation coefficient, the formula is as follows:

$${ZPxs}_{j} = {ω}_{1} \cdot {Q}_{\times {s}_{j}} - {ω}_{2} \cdot {DSxs}_{j} ;$$

where ZPxsⱼ is a comprehensive evaluation coefficient of the j-th individual, which is used to comprehensively evaluate the workpiece-tool performance by combining the workpiece surface quality coefficient and the tool life coefficient.

ω₁ and ω₂ are weights in a calculation of workpiece surface quality coefficient and tool life coefficient, respectively, and the specific values of ω₁ and ω₂ are determined by an analytic hierarchy process.

In some embodiments, the specific process of S5 is as follows:
optimizing the individual of the initial population iteratively; in the iterative optimization process, setting the constraint conditions of the tool edge parameters, that is, the maximum and minimum values of the rake angle, the relief angle, the edge radius and the fillet radius are set, respectively; within a constraint range of the rake angle, the relief angle, the edge radius and the fillet radius, the tool edge parameters are iteratively optimized; specifically, sorting the comprehensive evaluation coefficient DSxsⱼ from large to small, and selecting the individual with the comprehensive evaluation coefficient DSxsⱼ at a forefront as a parent generation, through crossover and mutation operations, exchanging, combining and mutating genes of the parent generation to generate new individuals, using the tool characteristic prediction model to obtain the tool cutting characteristic parameters of the newly generated individuals, and calculating the comprehensive evaluation coefficient, using new individuals and the parent generation as a new population, and repeating the selection, crossover and mutation operations until a predetermined number of iterations is reached, using the individual corresponding to a maximum value of the comprehensive evaluation coefficient as the optimal combination of tool edge parameters, calibrating the individual corresponding to the maximum value of the comprehensive evaluation coefficient as Qⱼ₁={Tⱼ₁, Hⱼ₁, R_{zj1}, αⱼ₁, βⱼ₁, rⱼ₁, Rⱼ₁}, then the optimal tool edge parameter combination is the rake angle αⱼ₁, the relief angle βⱼ₁, the edge radius rⱼ₁ and the rounding radius Rⱼ₁.

Compared with the existing technology, the beneficial effect of the present disclosure is as follows:

The present disclosure significantly enhances the intelligence of tool design by establishing a two-way feedback relationship between workpiece characteristic parameters and the cutting characteristic parameters of the tool. This mechanism not only enables real-time optimization of the tool design based on actual machining conditions, but also allows it to adapt effectively to varying machining scenarios, ensuring optimal tool performance in practical applications. At the same time, with the support of an intelligent tool characteristic prediction model, the cutting performance of the tool under specific workpiece and machining conditions can be predicted more accurately, thereby reducing unnecessary trial-and-error costs and improving precision at the design stage.

In addition, the comprehensive evaluation of tool and workpiece performance aims to achieve higher resource utilization efficiency in the machining process, reducing energy consumption and material costs, which in turn enhances production efficiency and product quality. The adoption of a genetic algorithm for optimization enables rapid exploration of the global optimal solution, making it particularly suitable for complex multi-dimensional parameter spaces while avoiding the local optimum traps that may arise with traditional methods.

### BRIEF DESCRIPTION OF THE DRAWINGS

FIG. 1 is a schematic diagram of the overall method flow of the present disclosure.

### DETAILED DESCRIPTION OF THE EMBODIMENTS

To provide a clearer understanding of the purpose, technical solutions, and advantages of the present disclosure, a further detailed description of the present disclosure will now be provided in conjunction with specific embodiments.

It should be noted that, unless otherwise defined, all technical and scientific terms used herein shall have the meanings commonly understood by a person of ordinary skill in the art to which this present disclosure belongs. Terms such as “first,” “second,” and the like used in this present disclosure do not denote any order, quantity, or importance, but are merely used to distinguish between different components. Words such as “comprising” or “including” mean that the elements or items preceding these terms encompass the elements or items listed thereafter and their equivalents, without excluding other elements or items. Terms such as “connected” or “connecting” are not limited to physical or mechanical connections, but may also include electrical connections, whether direct or indirect. Expressions such as “up,” “down,” “left,” and “right” are used only to indicate relative positional relationships. When the absolute position of the described object changes, the relative positional relationship may change accordingly.

### Example 1

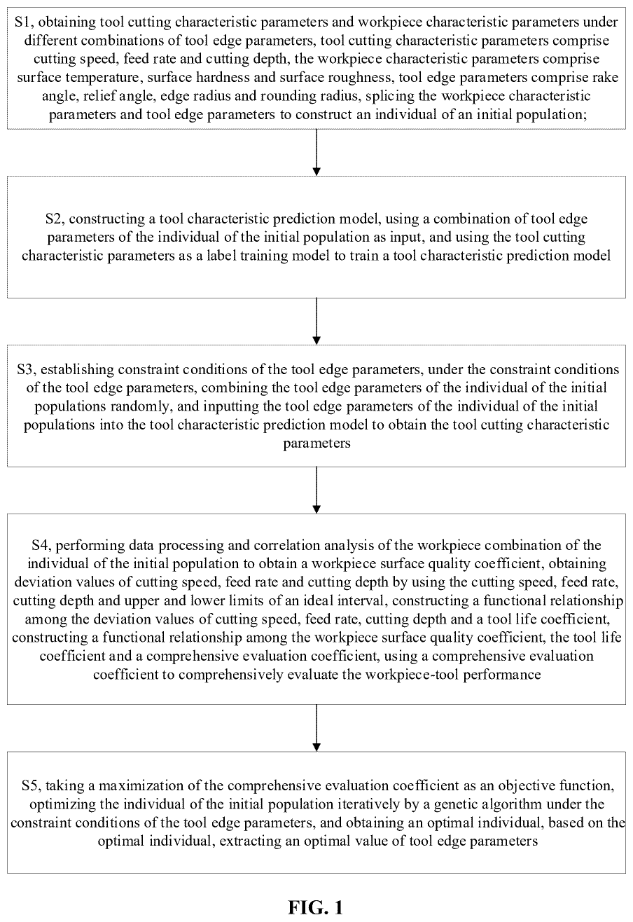

Refer to FIG. 1, the present disclosure provides a technical solution:

A tool edge parameter optimization method based on workpiece-tool performance parameters is proposed, the specific steps include:
S1, the tool cutting characteristic parameters and workpiece characteristic parameters under different combinations of tool edge parameters are obtained, tool cutting characteristic parameters include cutting speed, feed rate and cutting depth, the workpiece characteristic parameters include surface temperature, surface hardness and surface roughness, tool edge parameters include rake angle, relief angle, edge radius and rounding radius, the workpiece characteristic parameters and tool edge parameters are spliced to construct the individual of the initial population;
S2, a tool characteristic prediction model is constructed, the combination of tool edge parameters of the individual of the initial population is used as input, and the tool cutting characteristic parameters are used as a label training model to train the tool characteristic prediction model;
S3, the constraint conditions of the tool edge parameters are established, under the constraint conditions of the tool edge parameters, the tool edge parameters of the individual of the initial populations are combined randomly, and the tool edge parameters of the individual of the initial populations are input into the tool characteristic prediction model to obtain the tool cutting characteristic parameters;
S4, the data processing and correlation analysis of the workpiece combination of the individual of the initial population are performed to obtain a workpiece surface quality coefficient, the deviation values of cutting speed, feed rate and cutting depth are obtained by using the cutting speed, feed rate, cutting depth and upper and lower limits of an ideal interval, the functional relationship among the deviation values of cutting speed, feed rate, cutting depth and a tool life coefficient is constructed, the functional relationship among the workpiece surface quality coefficient, the tool life coefficient and a comprehensive evaluation coefficient is constructed, the comprehensive evaluation coefficient is used to comprehensively evaluate the workpiece-tool performance;
S5, the maximization of the comprehensive evaluation coefficient is taken as an objective function, the individual of the initial population is optimized iteratively by the genetic algorithm under the constraint conditions of the tool edge parameters, and an optimal individual is obtained, based on the optimal individual, the optimal value of tool edge parameters is extracted.

On the basis of the above implementation examples, the rake angle refers to the angle between the tool edge and the rake face of the tool, the larger the rake angle, the lower the cutting force and cutting temperature of the tool during cutting, and the better the machinability of the workpiece material;

the relief angle refers to the angle between the tool edge and the tool flank, the relief angle affects the cutting strength and wear resistance of the tool, a larger relief angle is beneficial to reduce the friction between the tool and the workpiece. A larger relief angle is beneficial to reduce the friction between the tool and the workpiece.

The edge radius refers to the smoothness of the cutting edge of the tool, which affects the stress distribution generated during the cutting process, an appropriate edge radius can improve the durability and cutting quality of the tool.

The fillet radius refers to the radius of the transition part of the tool edge, similar to the edge radius; it also helps to reduce the cutting force and wear.

The design of rake and relief angles will affect the heat and friction generated during the cutting process, larger rake angles tend to reduce the cutting temperature and help to improve tool life and workpiece quality.

The cutting characteristics of the tool (such as cutting speed and feed rate) are affected by the cutting edge parameters, which in turn affect the surface hardness of the workpiece, reasonable cutting parameters can avoid excessive wear and hardness loss.

The cutting edge parameters, especially the cutting edge radius and the rounding radius, have a direct impact on the surface smoothness of the workpiece, a smaller radius may lead to finer cutting particles and improve the surface roughness, while a proper rounding treatment can improve the surface quality.

The setting of rake angle and relief angle will affect the cutting efficiency and applicable cutting speed of the tool, a larger rake angle can usually improve the cutting speed, while a suitable relief angle can maintain good tool stability.

The combination of rake angle and relief angle affects the feed rate of the tool during cutting, the appropriate rake angle helps to reduce the cutting resistance, which can increase the feed rate and improve the production efficiency.

The design of the cutting edge radius and the rounding radius of the tool will affect the choice of the cutting depth, a larger cutting edge radius may increase the ability of the cutting depth, but it may also lead to an increase in the surface roughness of the workpiece.

On the basis of the above implementation examples, the acquisition equipment and methods of workpiece surface temperature, workpiece surface hardness and workpiece surface roughness are as follows:

The infrared thermometer is aligned with the contact area between the tool and the workpiece, and the surface temperature of the workpiece is recorded.

Using the Rockwell hardness tester, the sample is placed on the test platform of the Rockwell hardness tester, the initial load is applied, and the measurement load is applied after a period to read the surface hardness value of the workpiece.

By using the surface roughness instrument, the surface roughness instrument is placed on the surface of the workpiece and measured along the surface. The instrument will automatically collect the surface profile data and calculate the surface roughness of various workpieces.

The acquisition equipment and method of cutting speed, feed rate, cutting depth, rake angle, relief angle, cutting edge radius, and rounding radius are as follows:

The cutting speed (V=τ×D×n, where D is the tool diameter and n is the rotation speed) is calculated by measuring the actual rotation speed of the tool rotation shaft with a tachometer.

On the CNC machine tool, the feed rate is monitored and recorded by the CNC system.

On the CNC machine tool, the distance between the tool and the workpiece surface is measured by an electronic depth sounder or a vernier caliper, and the actual cutting depth is recorded.

The rake angle of the tool edge is observed and measured using an optical microscope.

The tool is fixed on the measuring table, and the relief angle of the tool is measured by an optical microscope.

The tool is placed under an optical microscope to observe the edge curve, and the radius of the edge is measured using a vernier caliper.

The tool is placed under an optical microscope to measure the radius of the rounded part of the tool edge.

On the basis of the above implementation examples, after collecting the surface temperature of the workpiece, the surface hardness of the workpiece, the surface roughness of the workpiece, the cutting speed, the feed rate, the cutting depth, the rake angle, the relief angle, the edge radius and the rounding radius, the above parameters are normalized by the maximum-minimum normalization processing, and then the normalized data is used for the later analysis and processing, so that all kinds of data are analyzed and processed under the same dimension in the later analysis and processing process, so as to avoid the problem that some data are ignored due to different dimensions.
where infrared thermometer, Rockwell hardness tester, surface roughness meter, tachometer, CNC machine tool, electronic sounder, and optical microscope can be used in the existing equipment models, there is no limit.

The surface temperature of the workpiece, the surface hardness of the workpiece, the surface roughness of the workpiece, the cutting speed, the feed rate, the cutting depth, the rake angle, the relief angle, the edge radius, and the rounding radius are all multiple groups (such as 3 groups). The same data measured multiple times is averaged, and the final mean value is used as the corresponding data in the material characteristic parameters of the workpiece, the cutting characteristic parameters of the tool, and the cutting edge parameters of the tool, so as to avoid the accidental error of the single point.

On the basis of the above implementation examples, the workpiece characteristic parameters and the tool edge parameters are spliced to construct the individual of the initial population of the tool edge parameters. The specific process is as follows:
the workpiece characteristic parameters are collected, including the workpiece surface temperature T, the workpiece surface hardness H and the workpiece surface roughness Rz; the combination of workpiece characteristic parameters are calibrated as B, and B={T, H, R_{Z}}, T, H, Rz denote the workpiece surface temperature, workpiece surface hardness and workpiece surface roughness in the combination of workpiece characteristic parameters, respectively; the initial population formed by splicing is calibrated as Q, and the initial population Q={Q₁, Q₂, . . . , Qⱼ, . . . , Qₘ}, Qⱼ is the j-th individual in the initial population, j is the index of the individual in the initial population, and j∈[1,m], m is the count of individuals in the initial population, Qⱼ={Tⱼ, Hⱼ, R_{z}_{ⱼ}, αⱼ, βⱼ, rⱼ Rⱼ}, where Tⱼ, Hⱼ, Rzⱼ, αⱼ, βⱼ, rⱼ, Rⱼ denote the workpiece surface temperature, workpiece surface hardness, workpiece surface roughness, rake angle, relief angle, edge radius and rounding radius of the j-th individual, respectively.

On the basis of the above implementation examples, the tool characteristic prediction model is composed of a deep neural network based on a multi-layer perceptron. The deep neural network of the multi-layer perceptron includes an input layer, a first hidden layer, a second hidden layer, a third hidden layer, and an output layer. The first hidden layer, the second hidden layer, and the third hidden layer all have at least two neurons, and all use ReLU as the activation function;

in this example, the input features of the deep learning network of the multi-layer perceptron include: rake angle, rake angle, edge radius, and rounding radius, four features.

The structure of the deep learning network of a multi-layer perceptron is:
Input layer: receiving the input of 4 features;
the first hidden layer: 64 neurons, using ReLU as the activation function;
the second hidden layer: 32 neurons, using ReLU activation function;
the third hidden layer: 16 neurons, using ReLU activation function;
output layer: a single neuron, tool cutting characteristic parameters.

The process of training the tool characteristic prediction model is as follows:

Taking the rake angle, relief angle, edge radius and chamfer radius of the individual of the initial population as the input, the tool cutting characteristic parameters as the output label for training, and the mean square error as the loss function, when the mean square error is within the range of [0, 0.01], the training of the tool characteristic prediction model is completed.

On the basis of the above implementation examples, the correlation between surface temperature, surface hardness, surface roughness and the surface quality of the workpiece is as follows:

When the tool works at high temperature, the wear speed is often accelerated, resulting in unstable cutting, which affects the surface quality of the workpiece. Therefore, the surface temperature of the workpiece and the surface quality of the workpiece are positively correlated.

In a certain range, materials with higher surface hardness can usually better resist wear and deformation, and the surface quality is better, so the surface hardness of the workpiece is positively correlated with the surface quality of the workpiece.

The greater the surface roughness, the more pronounced the surface irregularities, which directly impair the surface quality of the workpiece and reduce its smoothness and overall aesthetics. Therefore, the surface roughness of the workpiece is negatively correlated with its surface quality.

Based on the relationships among workpiece surface temperature, surface hardness, surface roughness, and surface quality, the surface temperature, surface hardness, and surface roughness of the workpiece are processed and analyzed to derive the workpiece surface quality coefficient. The formula is as follows:

$${Q}_{\times {s}_{j}} = \frac{{μ}_{1} \cdot {T}_{j} + {μ}_{2} \cdot {H}_{j}}{{μ}_{3} \cdot {RZ}_{j}} ;$$

where Q_{XSj} is the workpiece surface quality coefficient of the j-th individual, the workpiece surface quality coefficient is used to comprehensively evaluate an influence of the workpiece characteristic parameters on the workpiece surface quality from the three levels of workpiece surface temperature, workpiece surface hardness, and workpiece surface roughness, a higher workpiece surface quality coefficient denotes better workpiece surface quality;

μ₁ is a weight coefficient of the workpiece surface temperature, μ₂ is a weight coefficient of the workpiece surface hardness, and μ₃ is a weight coefficient of the workpiece surface roughness; The reason why the above function form is set to express the functional relationship between the workpiece surface quality coefficient and the surface temperature of the workpiece, the surface hardness of the workpiece and the surface roughness of the workpiece is as follows:

First, the formula puts the weighted sum of surface temperature and surface hardness in the form of molecules, so that the positive effects of temperature and hardness on surface quality can be fully reflected. At the same time, the surface roughness is in the denominator, indicating its negative impact on surface quality. On the whole, this design enables the quality coefficient to comprehensively evaluate the surface quality of the workpiece.

Second, the functional form ensures that the calculated quality coefficient carries a clear physical meaning: a higher Q_{XSj} value corresponds to better workpiece surface quality; elevated temperature and hardness values (as adjusted by their weights) contribute to an increase in the quality coefficient, whereas greater roughness leads to its reduction.

Third, through the introduction of weight coefficients (μ₁, μ₂, μ₃), the importance of each factor in evaluating the workpiece surface quality can be flexibly adjusted. This allows the evaluation process to be tailored to different application scenarios or specific requirements, thereby enhancing its accuracy and adaptability to diverse workpiece characteristics.

In many machining processes, surface temperature directly influences the physical properties of the material, such as plasticity, toughness, and fluidity. Higher temperatures often facilitate material forming and reduce defects, thereby improving surface quality. This is especially evident in metal processing and heat treatment, where temperature variation has a particularly significant impact on surface quality. Therefore, the weight coefficient μ₁ is assigned the highest value.

Surface hardness affects the wear resistance, scratch resistance, and fatigue resistance of materials, and generally plays an important role in surface quality assessment. However, compared to temperature, the influence of hardness is relatively smaller, as an increase in hardness is usually associated with specific treatment processes and cannot be significantly enhanced in all machining operations. Thus, the weight coefficient μ₂ is lower than the weight coefficient μ₁.

Surface roughness is generally regarded as a negative factor affecting surface quality. Excessive roughness can lead to increased friction, reduced fatigue life, and surface defects. Although the importance of roughness to the final surface quality cannot be overlooked, its weight coefficient in a comprehensive evaluation is typically smaller, because proper management of temperature and hardness can, to some extent, mitigate the negative effects of roughness. Therefore, the weight coefficient μ₃ is the smallest.

In summary, the weight coefficient for workpiece surface temperature is greater than that for workpiece surface hardness, and the weight coefficient for workpiece surface hardness is greater than that for workpiece surface roughness, that is, based on

$${μ}_{1} + {μ}_{2} + {μ}_{3} = 1 , let 0 < {μ}_{3} < {μ}_{2} < {μ}_{1} < 1.$$

As an implementation method, the value range of μ₁ is in an open interval of 0.4-0.5, the value range of μ₂ is in an open interval of 0.3-0.4, and the value range of μ₃ is in an open interval of 0.2-0.3. The specific value is set by the technical personnel according to the actual situation, and there is no restriction here.

Based on the above implementation example, the functional relationship among the deviation value of cutting speed, feed rate, cutting depth, and tool life coefficient is constructed, the formula is as follows:

$$\{ \begin{matrix}Δ {V}_{j} = \{ \begin{matrix}{V}_{1} - {V}_{j} & {V}_{j} < {V}_{1} \\ 0 & {V}_{1} \leq {V}_{j} \leq {V}_{2} \\ {V}_{j} - {V}_{2} & {V}_{j} > {V}_{2}\end{matrix} \\ Δ {f}_{j} = \{ \begin{matrix}{f}_{1} - {f}_{j} & {f}_{j} < {f}_{1} \\ 0 & {f}_{1} \leq {f}_{j} \leq {f}_{2} \\ {f}_{j} - {f}_{2} & {f}_{j} > {f}_{2}\end{matrix} \\ Δ {d}_{j} = \{ \begin{matrix}{d}_{1} - {d}_{j} & {d}_{j} < {d}_{1} \\ 0 & {d}_{1} \leq {d}_{j} \leq {d}_{2} \\ {d}_{j} - {d}_{2} & {d}_{j} > {d}_{2}\end{matrix}\end{matrix}$$

$${DSxs}_{j} = {ρ}_{1} \cdot Δ {V}_{j} + {ρ}_{2} \cdot Δ {f}_{j} + {ρ}_{3} \cdot Δ {d}_{j} ;$$

where ΔVⱼ is a cutting speed deviation value of the j-th individual, which is used to measure the degree of deviation of the cutting speed from the ideal interval As the deviation value decreases, the cutting speed becomes more ideal, thereby resulting in a smaller tool life coefficient and consequently, a longer tool life; Vⱼ is a cutting speed mean value of the j-th individual, V₁ is a lower limit value of an ideal interval of the cutting speed, V₂ is an upper limit value of the ideal interval of the cutting speed;

Δfⱼ is a feed deviation value of the j-th individual, which is used to measure the degree of feed deviation from the ideal interval, as the deviation value decreases, the feed rate becomes more ideal, thereby yielding a smaller tool life coefficient and ultimately a longer tool life fⱼ is a feed mean value of the j-th individual, f₁ is a lower limit value of an ideal interval of the feed, f₂ is an upper limit value of the ideal interval of the feed;

Δdⱼ is a cutting depth deviation value of the j-th individual, which is used to measure the degree of cutting depth deviating from the ideal interval, as the cutting depth deviation decreases, the cutting depth becomes more ideal, thus leading to a smaller tool life coefficient and a consequent extension of tool life. dⱼ is a cutting depth mean value of the j-th individual, d₁ is a lower limit value of the ideal interval of the cutting depth, d₂ is an upper limit value of the ideal interval of the cutting depth;

It should be noted that the lower and upper limits of the ideal interval of cutting speed, the lower and upper limits of the ideal interval of feed rate, and the lower and upper limits of the ideal interval of cutting depth can be obtained through the technical manual of tool machining.
where DSxsⱼ is a tool life coefficient of the j-th individual; the tool life coefficient is used to comprehensively evaluate an influence of tool cutting characteristic parameters on tool life from three levels: cutting speed, feed rate, and cutting depth. The smaller the tool life coefficient is, the longer the tool life is.

The establishment of the above functional form to express the relationship between the tool life coefficient and the deviation values of cutting speed, feed rate, and cutting depth is based on the following considerations:

First, cutting is a complex physical process involving the interaction of multiple variables. During cutting, cutting speed, feed rate, and cutting depth are key parameters affecting tool performance and life. Therefore, it is essential to quantify how deviations in these parameters influence tool life.

Second, each cutting parameter (cutting speed, feed rate, cutting depth) has an ideal range, which is typically provided by the tool manufacturer. These ideal values are thoroughly tested and verified to ensure optimal cutting performance and tool longevity.

By defining the deviation values (ΔVⱼ, Δfⱼ, Δdⱼ), the gap between actual parameters and ideal parameters can be quantified. The calculation method of the deviation value (as a piecewise function) can reflect the performance impact under different conditions.

Third, deviations in cutting speed, feed rate, and cutting depth directly affect the friction and temperature between the tool and the workpiece, thereby influencing the rate of tool wear. For example, excessively high cutting speed may cause the tool to overheat and shorten its life.

Ideal cutting parameters help improve cutting efficiency, reduce machining time, and lower energy consumption. An increase in deviation value generally denotes reduced machining efficiency, which affects production cost and tool life.

Fourth, the tool life coefficient (Dsxsⱼ) can be derived through a weighted summation of the deviation values, enabling a comprehensive evaluation of the influence of cutting speed, feed rate, and cutting depth on tool life. This functional form allows the specific impact of each deviation on tool life to be quantified.

By adjusting the weight coefficients (ρ₁, ρ₂, ρ₃), optimization and customization can be achieved according to different materials, tools, and machining conditions, thereby adapting to various processing environments.
where ρ₁, ρ₂ and ρ₃ are all predetermined proportional coefficients, ρ₁ is a weight of cutting speed deviation in evaluating an influence of cutting characteristic parameters on tool life; ρ₂ is a weight of feed deviation in evaluating the influence of cutting characteristic parameters on tool life, ρ₃ is a weight of cutting depth deviation in evaluating the influence of cutting characteristic parameters on tool life.

The higher the cutting speed deviation, the greater the friction between the tool and the workpiece, and the heat generated by the cutting, and the high temperature will lead to the softening and wear acceleration of the tool material. The feed rate directly affects the cutting amount per unit time. Excessive feed rate will increase the cutting force. Although the high feed rate deviation value will lead to accelerated tool wear, its influence is usually reflected by the applied cutting force and the physical bearing capacity of the tool. It is not as direct and rapid as the cutting speed to cause heat generation and a change in material properties. Therefore, when evaluating tool life, a higher weight ρ₁ is usually given to the cutting speed.

The feed rate directly determines the amount of material removed per revolution of the tool, excessive feed rate deviation will significantly increase the cutting force, resulting in accelerated tool wear. The increase in the cutting depth deviation will lead to a large cutting load, which will affect the durability and service life of the tool.

The feed rate directly determines the amount of material removed per revolution of the tool. Therefore, during actual machining, adjusting the feed rate can promptly influence the tool's cutting load and material removal efficiency. An excessively high feed rate deviation will immediately result in greater cutting force and accelerated tool wear. Although cutting depth also significantly affects the tool load, its impact often interacts with other machining parameters such as cutting speed and material properties. This denotes that the influence of cutting depth is not as direct or pronounced as that of the feed rate.

Therefore, although both feed rate and cutting depth have an important influence on tool life, the directness and sensitivity of feed rate in affecting tool wear and life make its influence considered to be more significant; ρ₂ is greater than ρ₃.

In summary, the weight coefficient of the cutting speed deviation value is greater than the weight coefficient of the feed deviation value, and the weight coefficient of the feed deviation value is greater than the weight coefficient of the cutting depth deviation value, that is, on the basis of β₁+ρ₂+ρ₃=1, let

$$0 < {ρ}_{3} < {ρ}_{2} < {ρ}_{1} < 1.$$

As an implementation method, the value range of μ₁ is in an open interval of 0.4-0.5, the value range of μ₂ is in an open interval of 0.3-0.4, and the value range of μ₃ is in an open interval of 0.2-0.3. The specific value is set by the technical personnel according to the actual situation, and there is no limit here.

On the basis of the above implementation examples, the functional relationship among the workpiece surface quality coefficient, the tool life coefficient, and the comprehensive evaluation coefficient is constructed, the formula is as follows:

$${ZPxs}_{j} = {ω}_{1} \cdot {Q}_{\times {s}_{j}} - {ω}_{2} \cdot {DSxs}_{j} ;$$

where ZPxsⱼ is a comprehensive evaluation coefficient of the j-th individual, which is used to comprehensively evaluate the workpiece-tool performance by combining the workpiece surface quality coefficient and the tool life coefficient. The comprehensive evaluation coefficient is positively correlated with workpiece-tool performance; a higher value corresponds to improved workpiece surface quality and longer tool life.

It should be noted that a higher workpiece surface quality coefficient (Qxsj) denotes better workpiece surface quality, while a larger tool life coefficient (Dsxsj) corresponds to a shorter tool life. Therefore, the comprehensive evaluation coefficient (ZPxsj) is positively correlated with Qxsj and negatively correlated with DSxsj. It is for this reason that the calculation formula for the comprehensive evaluation coefficient is established in the form presented above;

where ω₁ and ω₂ are weights in the calculation of workpiece surface quality coefficient and tool life coefficient, respectively, and the specific values of ω₁ and ω₂ are determined by the analytic hierarchy process, the specific logic is as follows:

The two indicators, namely the workpiece surface quality coefficient and the tool life coefficient, are marked; the relative importance between them is determined using the nine-scale method, and a judgment matrix is constructed. The workpiece surface quality coefficient is labeled as indicator 1, and the tool life coefficient is labeled as indicator 2, the constructed judgment matrix [qᵤᵥ]_{2×2} is:

$${[ {q}_{uv} ]}_{2 \times 2} = [ \begin{matrix}{q}_{11} , {q}_{12} \\ {q}_{21} , {q}_{22}\end{matrix} ] ;$$

where u and v denote the index of the coefficient, and u∈[1,2], v∈[1,2] denote the importance of the coefficient of indicator u relative to the coefficient of indicator v with respect to the comprehensive evaluation coefficient. The specific value of qᵤᵥ is determined by relevant experts using the 1-9 scoring method. qᵤᵥ=9 denotes that the coefficient of indicator u is extremely important compared to the coefficient of indicator v in relation to the comprehensive evaluation coefficient, while qᵤᵥ=1 denotes that the coefficient of indicator u is extremely unimportant compared to the coefficient of indicator v;

The value of each element in the judgment matrix is divided by the sum of its column to obtain the normalized judgment matrix. The average value of the elements in each row of the normalized judgment matrix is then calculated. The average of the first row is taken as the scaling coefficient for the workpiece surface quality coefficient, and the average of the second row as the scaling coefficient for the tool life coefficient. With the constraint that the sum of the scaled values equals 1, the two scaling coefficients are adjusted proportionally, and the resulting values are taken as the weights of the corresponding coefficients.

On the basis of the above implementation examples, the specific process of S5 is as follows:

The individual of the initial population is optimized iteratively; in the iterative optimization process, the constraint conditions of the tool edge parameters are set, that is, the maximum and minimum values of the rake angle, the relief angle, the edge radius and the fillet radius are set, respectively; within a constraint range of the rake angle, the relief angle, the edge radius and the fillet radius, the tool edge parameters are iteratively optimized; specifically, the comprehensive evaluation coefficient DSxsⱼ is sorted from large to small, and the individual with the comprehensive evaluation coefficient DSxsⱼ at a forefront is selected as a parent generation, the front refers to the individual in the top 50% of the comprehensive evaluation coefficient, through crossover and mutation operations, exchanging, combining and mutating genes of the parent generation to generate new individuals, the tool characteristic prediction model is used to obtain the tool cutting characteristic parameters of the newly generated individuals, and the comprehensive evaluation coefficient is calculated, new individuals and the parent generation are used as a new population, and the selection, crossover and mutation operations are repeated until the predetermined number of iterations is reached, the individual corresponding to the maximum value of the comprehensive evaluation coefficient is used as the optimal combination of tool edge parameters, the individual corresponding to the maximum value of the comprehensive evaluation coefficient is calibrated as Qⱼ₁={Tⱼ₁, Hⱼ₁, R_{z}_{ⱼ}₁, αⱼ₁, βⱼ₁, rⱼ₁, Rⱼ₁}, then the optimal tool edge parameter combination is the rake angle αⱼ₁, the relief angle βⱼ₁, the edge radius rⱼ₁ and the rounding radius Rⱼ₁.

The above formulas are used for dimensional numerical calculations. These formulas are derived from extensive data collection and software simulation to approximate real-world conditions. The predetermined parameters in the formulas are configured by technical professionals in the field based on actual application requirements.

The above implementation examples may be achieved wholly or in part through software, hardware, firmware, or any combination thereof. When implemented using software, the described implementations may be realized in whole or in part as computer program products. Technicians in this field will appreciate that the units and algorithm steps described in the examples disclosed herein can be implemented through a combination of electronic hardware and computer software. Whether a given function is implemented via hardware or software depends on the specific application and design constraints of the technical solution.

A unit described as a separate component may or may not be physically separated, and a component shown as a unit may or may not be a physical entity. It may be located in one place or distributed across multiple network units. Some or all of the units may be selected according to actual needs to achieve the objectives of the implementation.

The above descriptions represent only specific embodiments of this application; however, the scope of protection for this application is not limited thereto. Any person skilled in the art can readily conceive of modifications or substitutions within the technical scope disclosed in this application, which shall fall within the protection scope of this application.

What is claimed is:

1. A tool edge parameter optimization method based on workpiece-tool performance parameters, wherein the method comprises:
S1, obtaining tool cutting characteristic parameters and workpiece characteristic parameters for different combinations of tool edge parameters, wherein the tool cutting characteristic parameters comprise cutting speed, feed rate and cutting depth, and wherein the workpiece characteristic parameters comprise surface temperature, surface hardness and surface roughness, tool edge parameters comprise rake angle, relief angle, edge radius and rounding radius, and splicing the workpiece characteristic parameters and tool edge parameters to construct an individual of an initial population of tool edge parameters;
S2, constructing a tool characteristic prediction model, using a combination of tool edge parameters of the individual of the initial population of tool edge parameters as input, and using the tool cutting characteristic parameters as a label training model to train a tool characteristic prediction model;
S3, establishing constraint conditions of the tool edge parameters, under the constraint conditions of the tool edge parameters, combining the tool edge parameters of the individual of the initial populations of tool edge parameters randomly, and inputting the tool edge parameters of the individual of the initial populations of tool edge parameters into the tool characteristic prediction model to obtain the tool cutting characteristic parameters;
S4, performing data processing and correlation analysis of the workpiece combination of the individual of the initial population of tool edge parameters to obtain a workpiece surface quality coefficient, obtaining deviation values of cutting speed, feed rate and cutting depth by using the cutting speed, feed rate, cutting depth and upper and lower limits of an ideal interval, constructing a functional relationship among the deviation values of cutting speed, feed rate, cutting depth and a tool life coefficient, constructing a functional relationship among the workpiece surface quality coefficient, the tool life coefficient and a comprehensive evaluation coefficient, using a comprehensive evaluation coefficient to comprehensively evaluate the workpiece-tool performance; and
S5, taking a maximization of the comprehensive evaluation coefficient as an objective function, optimizing the individual of the initial population of tool edge parameters iteratively by a genetic algorithm under the constraint conditions of the tool edge parameters, obtaining an optimal individual, and, based on the optimal individual, extracting an optimal value of tool edge parameters.

2. The tool edge parameter optimization method based on workpiece-tool performance parameters according to claim 1, wherein splicing the workpiece characteristic parameters and tool edge parameters to construct the individual of the initial population of tool edge parameters, the specific process is as follows:
collecting workpiece characteristic parameters, comprising a workpiece surface temperature T, a workpiece surface hardness H and a workpiece surface roughness Rz; calibrating a combination of workpiece characteristic parameters as B, and B={T, H, R_{Z}}, T, H, Rz denote the workpiece surface temperature, workpiece surface hardness and workpiece surface roughness in the combination of workpiece characteristic parameters, respectively; calibrating the initial population of tool edge parameters formed by splicing as Q, and the initial population of tool edge parameters Q={Q₁, Q₂, . . . , Qⱼ, . . . , Qₘ}, Qⱼ is a j-th individual in the initial population of tool edge parameters, j is an index of the individual in the initial population of tool edge parameters, and j∈[1,m], m is a count of individuals in the initial population of tool edge parameters, Qⱼ={Tⱼ, Hⱼ, R_{z}_{ⱼ}, αⱼ, βⱼ, rⱼ, Rⱼ}, where Tⱼ, Hⱼ, Rzⱼ, αⱼ, βⱼ, rⱼ, Rⱼ denote the workpiece surface temperature, workpiece surface hardness, workpiece surface roughness, rake angle, relief angle, edge radius and rounding radius of the j-th individual, respectively.

3. The tool edge parameter optimization method based on workpiece-tool performance parameters according to claim 1, wherein the tool characteristic prediction model is composed of a deep neural network based on multi-layer perceptron; the deep neural network of the multi-layer perceptron comprises an input layer, a first hidden layer, a second hidden layer, a third hidden layer and an output layer; wherein the first hidden layer, the second hidden layer and the third hidden layer all have at least two neurons, and all use ReLU as the activation function;
wherein a process of training the tool characteristic prediction model is as follows:
taking the rake angle, relief angle, edge radius and rounding radius of the individual of the initial population of tool edge parameters as an input, and the tool cutting characteristic parameters as an output label, training with a mean square error as a loss function, wherein, when the mean square error is within a range of [0, 0.01], the training of the tool characteristic prediction model is completed.

4. The tool edge parameter optimization method based on workpiece-tool performance parameters according to claim 2, wherein processing the surface temperature, surface hardness, and surface roughness of the workpiece and performing a correlation analysis to obtain the workpiece surface quality coefficient, the formula is as follows:
$${Q}_{\times {s}_{j}} = \frac{{μ}_{1} \cdot {T}_{j} + {μ}_{2} \cdot {H}_{j}}{{μ}_{3} \cdot {RZ}_{j}} ;$$
where Q_{XSj} is the workpiece surface quality coefficient of the j-th individual, where the workpiece surface quality coefficient is used to comprehensively evaluate an influence of the workpiece characteristic parameters on the workpiece surface quality from the three levels of workpiece surface temperature, workpiece surface hardness and workpiece surface roughness; and where μ₁ is a weight coefficient of the workpiece surface temperature, μ₂ is a weight coefficient of the workpiece surface hardness, and μ₃ is a weight coefficient of the workpiece surface roughness; based on μ₁+μ₂+μ₃=1, let 0<μ₃<μ₂<μ₁<1.

5. The tool edge parameter optimization method based on workpiece-tool performance parameters according to claim 4, comprising constructing a function, wherein deviation of cutting speed, feed rate, cutting depth, and tool life coefficient are related by a formula as follows:
$$\{ \begin{matrix}Δ {V}_{j} = \{ \begin{matrix}{V}_{1} - {V}_{j} & {V}_{j} < {V}_{1} \\ 0 & {V}_{1} \leq {V}_{j} \leq {V}_{2} \\ {V}_{j} - {V}_{2} & {V}_{j} > {V}_{2}\end{matrix} \\ Δ {f}_{j} = \{ \begin{matrix}{f}_{1} - {f}_{j} & {f}_{j} < {f}_{1} \\ 0 & {f}_{1} \leq {f}_{j} \leq {f}_{2} \\ {f}_{j} - {f}_{2} & {f}_{j} > {f}_{2}\end{matrix} \\ Δ {d}_{j} = \{ \begin{matrix}{d}_{1} - {d}_{j} & {d}_{j} < {d}_{1} \\ 0 & {d}_{1} \leq {d}_{j} \leq {d}_{2} \\ {d}_{j} - {d}_{2} & {d}_{j} > {d}_{2}\end{matrix}\end{matrix}$$
$${DSxs}_{j} = {ρ}_{1} \cdot Δ {V}_{j} + {ρ}_{2} \cdot Δ {f}_{j} + {ρ}_{3} \cdot Δ {d}_{j} ;$$
where DSxsⱼ is a tool life coefficient of the j-th individual; the tool life coefficient is used to comprehensively evaluate an influence of tool cutting characteristic parameters on tool life from three levels: cutting speed, feed rate, and cutting depth.
ΔVⱼ is a cutting speed deviation value of the j-th individual, Vⱼ is a cutting speed mean value of the j-th individual, V₁ is a lower limit value of an ideal interval of the cutting speed, V₂ is an upper limit value of the ideal interval of the cutting speed, Δfⱼ is a feed deviation value of the j-th individual, fⱼ is a feed mean value of the j-th individual, f₁ is a lower limit value of an ideal interval of the feed, f₂ is an upper limit value of the ideal interval of the feed, Δdⱼ is a cutting depth deviation value of the j-th individual, dⱼ is a cutting depth mean value of the j-th individual, d₁ is a lower limit value of the ideal interval of the cutting depth, d₂ is an upper limit value of the ideal interval of the cutting depth;
ρ₁ is a weight of cutting speed deviation in evaluating an influence of cutting characteristic parameters on tool life; ρ₂ is a weight of feed deviation in evaluating the influence of cutting characteristic parameters on tool life, ρ₃ is a weight of cutting depth deviation in evaluating the influence of cutting characteristic parameters on tool life, and wherein, on the basis of ρ₁+ρ₂+ρ₃=1, 0<β₃<ρ₂<ρ₁<1.

6. The tool edge parameter optimization method based on workpiece-tool performance parameters according to claim 5, wherein constructing the functional relationship between the workpiece surface quality coefficient, the tool life coefficient, and the comprehensive evaluation coefficient, the formula is as follows:
$${ZPxs}_{j} = {ω}_{1} \cdot {Q}_{\times {s}_{j}} - {ω}_{2} \cdot {DSxs}_{j} ;$$
where ZPxsⱼ is a comprehensive evaluation coefficient of the j-th individual, which is used to comprehensively evaluate the workpiece-tool performance by combining the workpiece surface quality coefficient and the tool life coefficient;
ω₁ and ω₂ are weights in a calculation of workpiece surface quality coefficient and tool life coefficient, respectively, and the specific values of ω₁ and ω₂ are determined by an analytic hierarchy process.

7. The tool edge parameter optimization method based on workpiece-tool performance parameters according to claim 6, wherein the specific process of S5 is as follows:
optimizing the individual of the initial population of tool edge parameters iteratively; in the iterative optimization process, setting the constraint conditions of the tool edge parameters, that is, the maximum and minimum values of the rake angle, the relief angle, the edge radius and the fillet radius are set, respectively; within a constraint range of the rake angle, the relief angle, the edge radius and the fillet radius, the tool edge parameters are iteratively optimized; specifically, sorting the comprehensive evaluation coefficient DSxsⱼ from large to small, and selecting the individual with the comprehensive evaluation coefficient DSxsⱼ at a forefront as a parent generation, through crossover and mutation operations, exchanging, combining and mutating genes of the parent generation to generate new individuals, using the tool characteristic prediction model to obtain the tool cutting characteristic parameters of the newly generated individuals, and calculating the comprehensive evaluation coefficient, using new individuals and the parent generation as a new population of tool edge parameters, and repeating the selection, crossover and mutation operations until a predetermined number of iterations is reached, using the individual corresponding to a maximum value of the comprehensive evaluation coefficient as the optimal combination of tool edge parameters, calibrating the individual corresponding to the maximum value of the comprehensive evaluation coefficient as Qⱼ₁={Tⱼ₁, Hⱼ₁, R_{zj1}, αⱼ₁, βⱼ₁, rⱼ₁, Rⱼ₁}, then the optimal tool edge parameter combination is the rake angle αⱼ₁, the relief angle βⱼ₁, the edge radius rⱼ₁ and the rounding radius Rⱼ₁.
